(19) United States
(12) Patent Application Publication
(10) Pub. No.: US 2022/0234484 A1
(43) Pub. Date: Jul. 28, 2022

(54) Cup Holder Apparatus

(71) Applicants: Hyundai Motor Company, Seoul (KR); Kia Corporation, Seoul (KR); Seoyon E-Hwa Co., Ltd., Anyang-si (KR)

(72) Inventors: Do-Won Kim, Seoul (KR); Yong-Kyun Lee, Anyang-si (KR)

(21) Appl. No.: 17/313,053

(22) Filed: May 6, 2021

(30) Foreign Application Priority Data
Jan. 28, 2021 (KR) 10-2021-0012523

(51) Int. Cl. B60N 3/10

(52) U.S. Cl. CPC B60N 3/102; B60N 3/106

(57) ABSTRACT

An embodiment cup holder apparatus includes a cup holder bracket configured to be mounted on a door panel and disposed between the door panel and a door trim, a cup holder having a first side rotatably coupled to the cup holder bracket and a second side fastened to a latch mounted on the cup holder bracket, and a first holder and a second holder rotatably coupled to the cup holder and configured to be rotated when the cup holder is unfastened from the latch and rotated.

### CROSS-REFERENCE TO RELATED APPLICATIONS

This application claims the benefit of Korean Patent Application No. 10-2021-0012523, filed on Jan. 28, 2021, which application is hereby incorporated herein by reference.

### TECHNICAL FIELD

Exemplary embodiments of the present disclosure relate to a cup holder apparatus.

### BACKGROUND

In an indoor space of a vehicle, a cup holder on which various kinds of things or cups can be seated is provided in a space between a driver's seat and a passenger seat.

In case of a cup with a drink therein, since the drink may pour during vehicle operation, it is necessary to safely place the cup on the cup holder.

It can cause spatial limitations to provide a lot of space for cup placement in the indoor space of the vehicle, and in case of providing a separate space, other uses should be restricted.

Meanwhile, although design is considered to maximally secure a storage space even on a door trim, the storage space can be limited and insufficient due to a map pocket, full handle, and so on as functions of the door trim.

Accordingly, in case of applying the cup holder to the door trim, the internal space may be reduced due to the protruding design of the cup holder.

The above-described features of background technology are intended merely to aid in the understanding of the background of the present disclosure, and may include the features that are not the related art already known to those of ordinary skill in the art.

### SUMMARY

Exemplary embodiments of the present disclosure relate to a cup holder apparatus that is mounted on a door trim of a vehicle and in which a cup can be placed.

Exemplary embodiments of the present disclosure overcome the above disadvantages and other disadvantages not described above, and provide a cup holder apparatus which is mounted on a door trim to place a cup thereon and which does not reduce an internal space since the cup holder apparatus does not protrude toward the internal space when not in use.

Other features and advantages of embodiments of the present disclosure can be understood by the following description, and become apparent with reference to the embodiments of the present disclosure. Also, it is obvious to those skilled in the art to which the present disclosure pertains that the features and advantages of embodiments of the present disclosure can be realized by the means as claimed and combinations thereof.

In one embodiment of the present disclosure, a cup holder apparatus includes a cup holder bracket mounted on a door panel and disposed between the door panel and a door trim, and a cup holder having one side rotatably combined with the cup holder bracket and the other side fastened to a latch mounted on the cup holder bracket, wherein in case that the cup holder is unfastened from the latch and is rotated, a first holder and a second holder which are rotatably combined with the cup holder are rotated.

The cup holder further includes a first rotating pin combined with the cup holder bracket through penetration of the one side of the cup holder, and a first spring surrounding the first rotating pin and having one end combined with the cup holder and the other end combined with the cup holder bracket.

The cup holder includes a garnish part having a front surface formed side by side with a garnish mounted on the door trim, a first side part bent from one side surface of the garnish part, and a second side part bent from the other side surface of the garnish part.

A stopper protruding toward the cup holder is formed on the cup holder bracket, the other end of the first spring is combined with the stopper, and when the cup holder is rotated, the first side part comes in contact with the stopper and a turning radius thereof is limited.

A first damping gear is mounted on the cup holder bracket, and the first rotating pin penetrates the cup holder and a second damping gear tooth-engaged with the first damping gear is mounted on the cup holder.

A latch fastening part protruding to extend toward the cup holder bracket is formed adjacent to the second side part on a rear surface of the garnish part, and is fastened to the latch.

The cup holder further includes the first holder in an arc shape, a second rotating pin combined with the garnish part through penetration of one end part of the first holder, and a second spring surrounding the second rotating pin and having one end combined with the garnish part and the other end combined with the first holder.

A through-hole being penetrable by the latch fastening part is formed on a side of the one end part of the first holder.

When the cup holder is rotated around the first rotating pin as an axis, the first holder is rotated around the second rotating pin as an axis.

When the first holder is maximally rotated, the first holder comes in contact with the second side part, and a turning radius thereof is limited.

When the first holder is maximally rotated, a reaction force in an opposite rotation direction is applied to the first holder by the second spring.

The cup holder further includes the second holder in an arc shape, a third rotating pin combined with the garnish part through penetration of one end part of the second holder, and a third spring surrounding the third rotating pin and having one end combined with the garnish part and the other end combined with the second holder, wherein when the cup holder is rotated around the first rotating pin as an axis, the second holder is rotated around the third rotating pin as an axis.

The first holder is disposed more adjacent to the second side part than the second holder, and an arc length of the first holder is longer than an arc length of the second holder.

The cup holder bracket includes a cup holder seat part supporting a bottom surface of the cup holder, and a cup holder accommodation part formed to upwardly protrude in an arc shape corresponding to the first holder from one side of the cup holder seat part.

In another embodiment of the present disclosure, a cup holder apparatus includes a cup holder bracket disposed between a door panel and a door trim, a garnish part having a front surface mounted side by side with a garnish mounted on the door trim, a first holder in an arc shape and rotatably combined with a rear surface of the garnish part, and a second holder in an arc shape and rotatably combined with the rear surface of the garnish part, wherein one side of the garnish part is rotatably combined with the cup holder bracket and the other side of the garnish part is fastened to a latch mounted on the cup holder bracket, and in case that the garnish part is unfastened from the latch and is rotated, insides of arcs of the first holder and the second holder are unfolded to face each other.

The cup holder apparatus further includes a second rotating pin combined with the garnish part through penetration of one end part of the first holder, a second spring surrounding the second rotating pin and having one end combined with the garnish part and the other end combined with the first holder, a third rotating pin combined with the garnish part through penetration of one end part of the second holder, and a third spring surrounding the third rotating pin and having one end combined with the garnish part and the other end combined with the second holder.

The cup holder apparatus includes a first side part bent from one side surface of the garnish part, and a second side part bent from the other side surface of the garnish part, wherein when the first holder is maximally rotated, the first holder comes in contact with the second side part and a turning radius thereof is limited, and when the first holder is maximally rotated, a reaction force in an opposite rotation direction is applied to the first holder by the second spring.

The first holder is disposed more adjacent to the other side of the garnish part than the second holder, and an arc length of the first holder is longer than an arc length of the second holder.

The cup holder apparatus according to embodiments of the present disclosure is harmonized with the door trim skin and molding design, and thus does not impair the appearance.

Further, since the cup holder apparatus does not protrude out of the door trim when not in use, it does not reduce the internal space.

That is, the cup holder apparatus can be used in a manner that it protrudes out of the door trim only when in use and is adjusted to match the size of the cup.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a state in which a cup holder apparatus according to embodiments of the present disclosure is mounted on a door trim.

FIG. 2 schematically illustrates a cup holder apparatus according to embodiments of the present disclosure.

FIG. 3 illustrates a planar cross-sectional shape of a cup holder apparatus according to embodiments of the present disclosure.

FIGS. 4 and 5 illustrate a state in which a cup holder apparatus according to embodiments of the present disclosure is in operation.

FIG. 6 illustrates a state in which a cup holder apparatus according to embodiments of the present disclosure is completely operated.

FIG. 7 illustrates an adjustment state of a cup holder apparatus according to embodiments of the present disclosure.

### DETAILED DESCRIPTION OF ILLUSTRATIVE EMBODIMENTS

In order to fully understand the present disclosure, advantages in operation of the present disclosure, and objects being achieved by embodying the present disclosure, the accompanying drawings illustrating preferred embodiments of the present disclosure and the contents described in the accompanying drawings should be referred to.

In describing the preferred embodiments of the present disclosure, explanations of known technologies or repeated explanations, which may unnecessarily obscure the gist of the present disclosure, will be reduced or omitted.

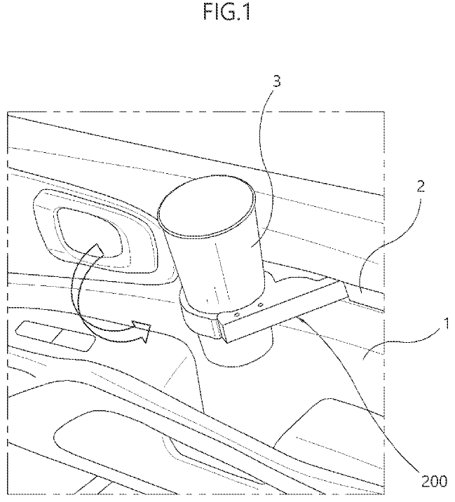

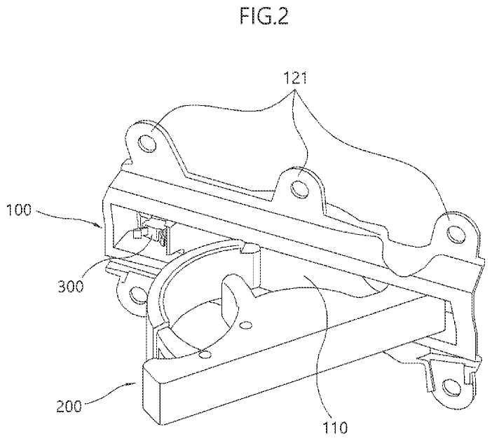

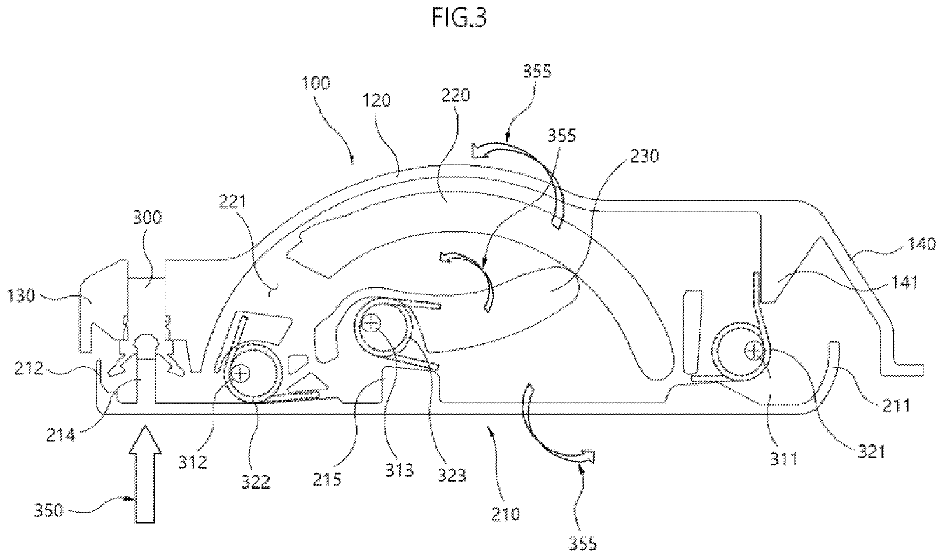

FIG. 1 illustrates a state in which a cup holder apparatus according to embodiments of the present disclosure is mounted on a door trim, and FIG. 2 schematically illustrates a cup holder apparatus according to embodiments of the present disclosure. FIG. 3 illustrates a planar cross-sectional shape of a cup holder apparatus according to embodiments of the present disclosure.

Hereinafter, referring to FIGS. 1 to 3, a door trim including a cup holder apparatus according to an embodiment of the present disclosure will be described.

The cup holder apparatus according to embodiments of the present disclosure is an apparatus which is mounted on a door trim 1 and in which a cup 3 is able to be fitted and placed onto a cup holder 200 as shown in FIG. 1. The cup holder apparatus has an integral design with a garnish 2 on the door trim 10, and can overcome spatial limitations in a manner that the cup holder 200 does not protrude out of the door trim 1 using a hidden space in the door trim 1 when not in use, whereas it protrudes to be used as shown in FIG. 1 only when in use.

For this, the cup holder apparatus includes a cup holder bracket 100, a cup holder 200, and a latch 300, and the cup holder 200 forms one part of the garnish 2 in appearance when not in use, whereas the cup holder 200 is rotated to function as the cup holder when in use.

The cup holder bracket 100 is disposed in a space between the door trim 1 and a door panel and is fixedly mounted on the door panel, and includes a cup holder seat part no, a cup holder accommodation part 120, a cup holder fastening part 13o, and a cup holder support part 140.

The cup holder seat part no is configured to be in a flat plate shape with predetermined width and length to support a bottom surface of the cup holder 200, and the cup holder accommodation part 120 is configured to upwardly protrude in an arc shape from one side of the cup holder seat part no and to accommodate and support the cup holder 200 in a bent state before operation.

The cup holder fastening part 130 is configured to be connected to one side of the cup holder accommodation part 120 and to protrude upward from the cup holder seat part 110, and the latch 300 is mounted thereon to be fastened to or unfastened from the cup holder 200. The cup holder support part 140 is configured to be connected to the other side of the cup holder accommodation part 120 and to protrude upward from the cup holder seat part no, and by a stopper 141 protruding sideward, the operation of the cup holder 200 is supported and the radius of the cup holder 200 is limited.

Further, a door trim mount part 121 may be formed on upper and lower sides of the cup holder seat part no, the cup holder fastening part 13o, and the cup holder support part 14o, and may be combined with the door trim 1 by a bolt penetrating the door trim mount part 121.

The cup holder 200 has one side rotatably combined with the cup holder support part 140 and the cup holder seat part no, and the other side fastened to the latch 300 or unfastened from the latch 300 so that the other side is rotated and protrudes to an outside of the door trim 1 to enable the cup 3 to be seated on the cup holder 200.

The cup holder 200 includes a garnish part 210, a first holder 220, and a second holder 230.

The garnish part 210 has a garnish 2 mounted on the door trim 1 and in particular, a front part that is side by side with a front surface of a skin or molding, and implements an integral feeling with the garnish 2 before being operated.

Further, the first holder 220 and the second holder 230 are combined with a rear surface of the front part, an upper part 213 extends from an upper end of the front part, and a lower part that is side by side with the upper part 213 extends from a lower end of the front part.

A first rotating pin 311 that penetrates the upper part 213, the lower part, and the cup holder seat part no is combined with one side of the upper part 213, and a first spring 321 surrounds the first rotating pin 311 and has one end combined with the garnish part 210 and the other end combined with the stopper 141 of the cup holder support part 140.

Accordingly, if the cup holder 200 is unfastened from the latch 300, the cup holder 200 is rotated toward the inside of the vehicle by an elastic force of the first spring 321.

The rotation angle may be maximally 56°.

On one of the two side surfaces of the garnish part 210, a first side part 211 bent from the garnish part 210 toward the cup holder seat part no is formed, and on the other side surface thereof, a second side part 212 bent from the garnish part 210 toward the cup holder seat part no is formed.

If the cup holder 200 is unfastened from the latch 300 and is rotated, the first side part 211 comes in contact with the stopper 141 and a turning radius thereof is limited.

Further, a latch fastening part 214 is formed to extend from the rear surface of the garnish part 210 that is adjacent to the second side part 212 toward the cup holder seat part 110, and is inserted into the latch 300 to be combined with the latch 300, and if an external force is applied toward the latch 300, the latch fastening part 214 is unfastened from the latch 300.

Further, in the middle of the rear surface thereof, a second holder support part 215 is formed to project, and thus the second holder 230 can be supported by the second holder support part 215.

Next, the first holder 220 is combined by a second rotating pin 312 that penetrates one end part of the first holder 220 and the upper part 213 and the lower part of the garnish part 210, and a second spring 322 surrounds the second rotating pin 312 and has one end combined with the garnish part 210 and the other end combined with one end part of the first holder 220. The first holder 220 is combined adjacent to the latch fastening part 214 toward the center of the garnish part 210 rather than the latch fastening part 214.

The first holder 220 is formed in an arc shape in plane from one end part thereof to the other end part thereof, the center of the arc is directed toward the center of the garnish part 210 and the first side part 211, and the first holder 220 forms the shape capable of grasping the cup 3 together with the second holder 230 that faces the first holder 220.

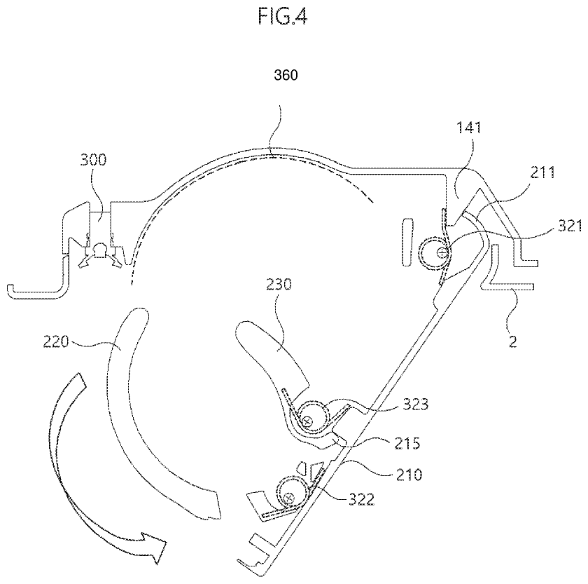

Accordingly, before the cup holder 200 is operated, the second spring 322 is compressed, and the first holder 220 is folded toward the garnish part 210 to be seated on an inner surface of the cup holder accommodation part 120. If the cup holder 200 is unfastened from the latch 300, the second spring 322 is restored as shown in FIG. 4, and the first holder 220 is rotated and unfolded in a direction in which the first holder 220 gets farther apart from the garnish part 210.

During such an operation, a through-hole 221 is formed on the side of one end part to prevent the first holder 220 from coming in contact with the latch fastening part 214 of the garnish part 210.

The second holder 230 is combined by a third rotating pin 313 that penetrates one end part of the second holder 230 and the upper part 213 and the lower part of the garnish part 210, and a third spring 323 surrounds the third rotating pin 313 and has one end combined with the second holder support part 215 of the garnish part 210 and the other end combined with one end part of the second holder 230.

The second holder 230 is formed in an arc shape in plane from one end part thereof to the other end part thereof, the center of the arc is directed toward the first holder 220 to face the first holder 220, and the second holder 230 forms the shape capable of grasping the cup 3 together with the first holder 220.

Accordingly, before the cup holder 200 is operated, the third spring 323 is compressed, and the second holder 230 is folded toward the garnish part 210 to be disposed in the form surrounded by the first holder 220. If the cup holder 200 is unfastened from the latch 300, the third spring 323 is restored as shown in FIG. 4, and the second holder 230 is rotated and unfolded in a direction in which the second holder 230 gets farther apart from the garnish part 210.

The spring force of the third spring 323 may be set so that the rotation angle from a state before the operation of the second holder 230 to a state after the operation of the second holder 230 becomes, for example, 59.5°.

The operation is illustrated by the arrows in FIG. 3. As illustrated by arrow 350, when a push weight is applied to a corresponding section, the cup holder appears due to the latch release and spring action force. Arrows 355 illustrate that a reaction force is caused by the spring is in action.

FIG. 4 illustrates the guide structure is applied, in which the cup holder is unfolded according to the bracket trajectory and is folded when not in use. The cup holder operation trajectory is shown by the broken line 360.

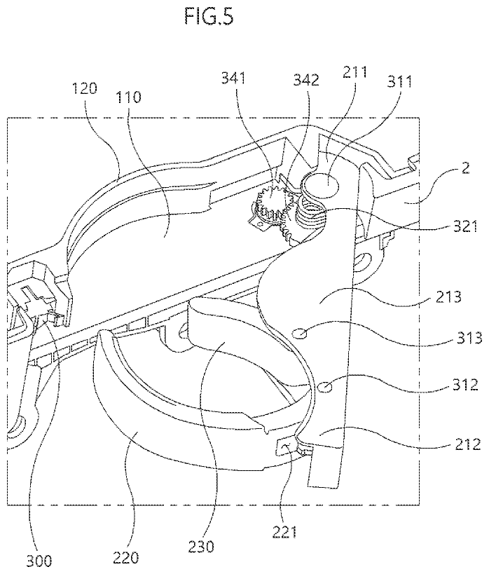

Meanwhile, referring to FIG. 5, a second damping gear 342 may be combined with the lower part of the garnish part 210 with which the first rotating pin 311 is combined, and the first rotating pin 311 may be combined through penetration of the second damping gear 342.

Further, a first damping gear 341 that is tooth-engaged with the second damping gear 342 may be formed on the cup holder seat part 110.

Accordingly, during an opening operation as shown in FIG. 4, the second damping gear 342 is rotated and operated by the engaged first damping gear 341, and thus, during a pop-up by the force of the first spring 321, the second damping gear 342 is popped up on a slow motion to improve the emotional quality.

Further, it is more preferable in operation that the first holder 220 having a large turning radius is longer than the second holder 230.

As illustrated by FIG. 5, luxuriousness of the vehicle is improved by having the cup holder slowly popped up by the spring caused by applying a gear type oil damper to the bracket.

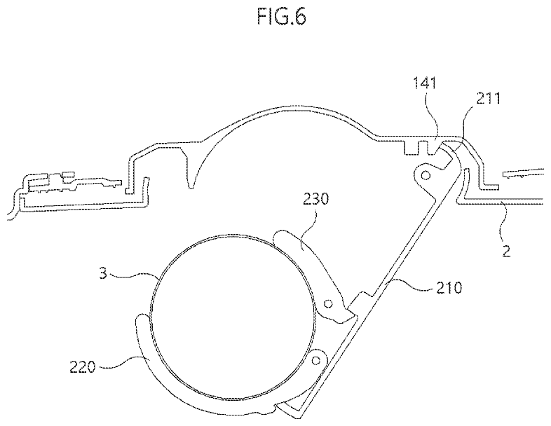

In the unfolded state as shown in FIG. 4 through the above-described operation, the cup 3 can be fitted and placed onto the insides of the first holder 220 and the second holder 230 as shown in FIG. 6 by maximally rotating the first holder 220, and in this case, the first holder 220 comes in contact with the end of the second side part 212, and further rotation of the first holder 220 is blocked by the second side part 212.

The maximum rotation angle in a state where the first holder 220 is operated may be, for example, 109°.

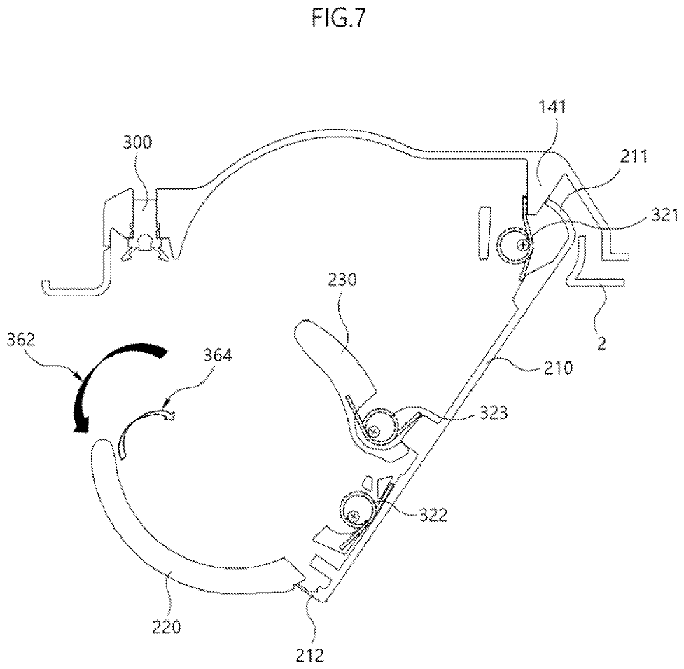

Further, if the first holder 220 is further rotated by an external force than the state of FIG. 4 in which the first holder 220 is unfolded by a set spring force as shown in FIG. 7, a reaction force by the second spring 322 is incurred on the side of the second holder 230. This allows the cup holder to be adjustable according to cup size due to the first holder spring reaction force. The arrows 362 and 364 show the reaction force caused the spring in action.

Accordingly, by such a reaction force, the first holder 220 is adjusted to match the size of the cup, and thus the cup can be placed on the first holder 220.

As described above, according to the cup holder apparatus according to embodiments of the present disclosure and the door trim including the same, since the door trim is not exposed in appearance, the constraints in space and design are not broken, and since the cup can be placed by operating the cup holder if necessary, the convenience of the internal space of the vehicle can be improved.

While the present disclosure has been described with reference to the exemplified drawings, the present disclosure is not limited to the described embodiments, and it will be apparent to those of ordinary skill in the art that various changes and modifications may be made without departing from the spirit and scope of the present disclosure. Accordingly, such examples of changes and modifications should belong to the claims of the present disclosure, and the scope of rights of the present disclosure should be interpreted based on the appended claims.

What is claimed is:

1. A cup holder apparatus comprising:
a cup holder bracket configured to be mounted on a door panel and disposed between the door panel and a door trim;
a cup holder having a first side rotatably coupled to the cup holder bracket and a second side fastened to a latch mounted on the cup holder bracket; and
a first holder and a second holder rotatably coupled to the cup holder and configured to rotate when the cup holder is unfastened from the latch and rotated.

2. The cup holder apparatus according to claim 1, wherein the cup holder further comprises:
a first rotating pin coupled to the cup holder bracket through penetration of the first side of the cup holder; and
a first spring surrounding the first rotating pin and having a first end coupled to the cup holder and a second end coupled to the cup holder bracket.

3. The cup holder apparatus according to claim 2, further comprising:
a first damping gear mounted on the cup holder bracket; and
a second damping gear mounted on the cup holder and tooth-engaged with the first damping gear.

4. The cup holder apparatus according to claim 2, wherein the cup holder comprises:
a garnish part having a front surface configured to be disposed side by side with a garnish mounted on the door trim;
a first side part bent from a first side surface of the garnish part; and
a second side part bent from a second side surface of the garnish part.

5. The cup holder apparatus according to claim 4, further comprising a stopper formed on the cup holder bracket and protruding toward the cup holder, wherein:
the second end of the first spring is coupled to the stopper; and
the first side part is configured to come into contact with the stopper when the cup holder is rotated and a turning radius of the cup holder is limited.

6. The cup holder apparatus according to claim 5, further comprising a latch fastening part formed adjacent to the second side part on a rear surface of the garnish part and protruding to extend toward the cup holder bracket, wherein the latch fastening part is configured to be fastened to the latch.

7. The cup holder apparatus according to claim 6, further comprising a through-hole on a side of a first end part of the first holder, wherein the through-hole is configured to be penetrable by the latch fastening part.

8. A cup holder apparatus comprising:
a cup holder bracket configured to be mounted on a door panel and disposed between the door panel and a door trim;
a cup holder having a first side rotatably coupled to the cup holder bracket and a second side fastened to a latch mounted on the cup holder bracket, wherein the cup holder comprises:
a first rotating pin coupled to the cup holder bracket through penetration of the first side of the cup holder;
a first spring surrounding the first rotating pin and having a first end coupled to the cup holder and a second end coupled to the cup holder bracket;
a garnish part having a front surface configured to be disposed side by side with a garnish mounted on the door trim;
a first side part bent from a first side surface of the garnish part;
a second side part bent from a second side surface of the garnish part;
a second rotating pin coupled to the garnish part; and
a second spring surrounding the second rotating pin and having a first end coupled to the garnish part; and
a first holder and a second holder rotatably coupled to the cup holder;
wherein the first holder is in an arc shape;
wherein the second rotating pin is coupled to the garnish part through penetration of a first end part of the first holder;
wherein a second end of the second spring is coupled to the first holder; and
wherein the first holder and the second holder are configured to rotate when the cup holder is unfastened from the latch and is rotated.

9. The cup holder apparatus according to claim 8, wherein the first holder is configured to be rotated around the second rotating pin as an axis when the cup holder is rotated around the first rotating pin as an axis.

10. The cup holder apparatus according to claim 9, wherein the first holder is configured to come in contact with the second side part when the first holder is maximally rotated, and a turning radius of the first holder is limited.

11. The cup holder apparatus according to claim 9, wherein the second spring is configured to apply to the first holder a reaction force in an opposite rotation direction when the first holder is maximally rotated.

12. The cup holder apparatus according to claim 8, wherein the second holder is in an arc shape, and wherein the cup holder further comprises:
a third rotating pin coupled to the garnish part through penetration of a first end part of the second holder; and
a third spring surrounding the third rotating pin and having a first end coupled to the garnish part and a second end coupled to the second holder,
wherein the second holder is configured to be rotated around the third rotating pin as an axis when the cup holder is rotated around the first rotating pin as an axis.

13. The cup holder apparatus according to claim 12, wherein:
the first holder is disposed more adjacent to the second side part than the second holder; and
an arc length of the first holder is longer than an arc length of the second holder.

14. The cup holder apparatus according to claim 12, wherein the cup holder bracket comprises:
a cup holder seat part supporting a bottom surface of the cup holder; and
a cup holder accommodation part upwardly protruding in an arc shape corresponding to the first holder from one side of the cup holder seat part.

15. A cup holder apparatus comprising:
a cup holder bracket configured to be disposed between a door panel and a door trim;
a garnish part having a front surface configured to be mounted side by side with a garnish mounted on the door trim, wherein a first side of the garnish part is rotatably coupled to the cup holder bracket and a second side of the garnish part is fastened to a latch mounted on the cup holder bracket;
a first holder in an arc shape and rotatably coupled to a rear surface of the garnish part; and
a second holder in an arc shape and rotatably coupled to the rear surface of the garnish part,
wherein insides of arcs of the first holder and the second holder are configured to be unfolded to face each other when the garnish part is unfastened from the latch and is rotated.

16. The cup holder apparatus according to claim 15, further comprising:
a second rotating pin coupled to the garnish part through penetration of a first end part of the first holder;
a second spring surrounding the second rotating pin and having a first end coupled to the garnish part and a second end coupled to the first holder;
a third rotating pin coupled to the garnish part through penetration of a first end part of the second holder; and
a third spring surrounding the third rotating pin and having a first end coupled to the garnish part and a second end coupled to the second holder.

17. The cup holder apparatus according to claim 16, further comprising:
a first side part bent from a first side surface of the garnish part; and
a second side part bent from a second side surface of the garnish part, wherein the first holder is configured to come in contact with the second side part when the first holder is maximally rotated, and a turning radius of the first holder is limited.

18. The cup holder apparatus according to claim 16, further comprising:
a first side part bent from a first side surface of the garnish part; and
a second side part bent from a second side surface of the garnish part, wherein the third spring is configured to apply to the first holder a reaction force in an opposite rotation direction when the first holder is maximally rotated.

19. The cup holder apparatus according to claim 15, wherein:
the first holder is disposed more adjacent to the second side of the garnish part than the second holder; and
an arc length of the first holder is longer than an arc length of the second holder.
